(19) United States
(12) Patent Application Publication
(10) Pub. No.: US 2012/0246003 A1
(43) Pub. Date: Sep. 27, 2012

(54) Advertisement Service

(76) Inventors: Gregory M. Hart, Mercer Island, WA (US); Elmore Eugene Pope, Sammamish, WA (US); Charles H. Bell, Redmond, WA (US); Jeffrey P. Bezos, Greater Seattle, WA (US); Nadia Shouraboura, Newcastle, WA (US)

(21) Appl. No.: 13/052,930

(22) Filed: Mar. 21, 2011

(51) Int. Cl. G06Q 30/00

(52) U.S. Cl. 705/14.57; 705/14.58

(57) ABSTRACT

An advertisement service allows advertisers to obtain a right to provide an advertisement to a mobile device that is located within or nearby a particular geographic region. For instance, the advertisement service may map one or more entities (e.g., retailers, schools, museums, etc.) to a geographic region at which these entities are located. The advertisement service provides an offer to one or more advertisers to provide an advertisement to a mobile device located within or nearby one of these geographic regions. Based on responses received to the offer, the advertisement service provides information to the mobile device for display of an advertisement.

### BACKGROUND

A large and growing population of people utilize one or more mobile electronic devices in their daily life. These devices are used for activities such as scheduling events, making phone calls, shopping, interacting with others online and many different types of entertainment including games and consumption of digital content items, such as music, movies, images and books, among others. Among these mobile devices are smart phones, cellular telephones, personal digital assistants (PDAs), portable media players, electronic book readers, laptops, tablets, netbooks and the like.

As more and more users utilize these mobile devices, more and more content is being made available for consumption on these devices. For instance, users often utilize mobile devices to not only make and receive phone calls, but also to find directions to desired destinations, download desired applications, listen to music and the like. In addition, these mobile devices are often location aware, or are otherwise able to provide content providers with the location of the mobile device. With this information, content providers may tailor content served to the mobile devices.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an architecture of computers and networks in which an advertisement service maps entities to geographical regions. With use of this map, the advertisement service may provide advertisements to mobile devices when users of these mobile devices enter a particular geographical region. Further, the advertisement service may allow advertisers to provide these advertisements to these mobile devises.

FIGS. 2A-2B illustrate how the advertisement service may define three-dimensional regions of a physical space, associate each region with a particular entity (e.g., a retailer) and assign one or more advertisers to each region. By doing so, the advertisement service may provide advertisements from the assigned advertiser(s) to mobile devices that enter the corresponding defined region.

FIG. 3 depicts example components of the advertisement service from FIG. 1.

FIG. 4 illustrates an example user interface (UI) that the advertisement service may serve to a computing device of an advertiser that desires to acquire a right to provide advertisements to mobile devices in a particular geographical region.

FIG. 5 illustrates an example advertisement that the advertisement service may provide when a mobile device enters the particular geographical region shown in FIG. 4.

FIG. 6 illustrates an example advertisement that the advertisement service may provide within an application on a mobile device.

FIG. 7 illustrates an example advertisement that the advertisement service may provide within an electronic mail message on a mobile device.

FIG. 8 depicts one possible scenario for associating an entity with a geographical region, placing an offer to a group of advertisers to advertise to mobile devices within the region and providing a particular advertisement to a mobile device.

FIGS. 9A-9B depict one possible scenario for defining multiple geographic regions, offering advertisers a right to provide advertisements to mobile devices within this region and providing such advertisements to these mobile devices.

FIG. 10 depicts additional example components that a server of the advertisement service may store or otherwise have access to.

FIG. 11 depicts additional example components that a mobile device of the architecture of FIG. 1 may store or otherwise have access to.

### DETAILED DESCRIPTION

This disclosure describes an architecture and techniques for enabling advertisers to obtain a right to display ad content to mobile devices that are located within or nearby a particular geographical region. For instance, this disclosure describes, in part, an advertisement service that maps entities (e.g., retailers, gas stations, suppliers, schools, museums, etc.) to geographical regions at which these entities are located. The advertisement service offers one or more advertisers the ability to compete to provide ad content to a mobile device at these locations. In one example, the advertisement service allows one or more advertisers, who are competitors of the entity the mobile device is located within or nearby, to bid based on the entity (or portion of the entity) identified by the advertisement service. Upon an advertiser providing a winning bid to provide ad content to a mobile device, the advertisement service may provide ad content from this advertiser to the mobile device located in that particular geographical location.

To illustrate, the advertisement service may have access to a map of one or more retailers corresponding to geographical regions at which these retailers or entities are located. For instance, an example retailer, “Electronics Warehouse,” may be mapped to each geographical location at which this retailer has a physical (e.g., brick-and-mortar) storefront, and the advertisement service may represent each “Electronics Warehouse” (or any portion thereof) with one or more geographic regions. Each geographic region may comprise any two- or three-dimensional space, such as a set of Global Positioning Satellite (GPS) coordinates or a set of GPS coordinates and an elevation measurement.

Certain advertisers may be interested in placing bids for the opportunity to display competitive advertisements to mobile devices of users that are located at or near an “Electronics Warehouse” store. For instance, competitors of “Electronics Warehouse” may place bids to provide ad content (e.g., an advertisement) on a mobile device currently located within an “Electronics Warehouse” store (or some portion of the store).

In one example, envision that a user is shopping for a flat-screen television at an “Electronics Warehouse” brick-and-mortar store. While in the store, the user takes a phone call, sends or receives an email or decides to check the weather outside by opening a weather application on her mobile device. Upon initiating any of these tasks (e.g., selecting the weather application) or other actions, the advertising service receives an indication that the mobile device, with an available impression (e.g., space is available in the weather UI to place an advertisement), is located within a geographical region associated with the “Electronics Warehouse” store. In one embodiment, the advertising service conducts an auction by sending bid requests to advertisers to bid to place ad content from possible “Electronics Warehouse” competitors in the available impression on the mobile device. Based on the information contained in the bid request (e.g., “Electronics Warehouse,” anonymized user information, display time, type of mobile device, brand of mobile device, context of ad format, etc.), a competitor of “Electronics Warehouse” (e.g., “Acme TV”) places a winning bid and, therefore, secures a right to select an advertisement to fill the available impression in the weather application when the weather application page is rendered. This advertisement may indicate that “Acme TV” is running a sale on televisions, may indicate that “Acme TV” will beat any price offered by “Electronics Warehouse,” and/or the like. Upon viewing the ad, the user of the mobile device may decide to conduct a transaction with “Acme TV” rather than with “Electronics Warehouse,” such as at a brick-and-mortar location of “Acme TV,” via an online “Acme TV” store or the like.

In some embodiments, the user does not have to initiate any tasks for the advertising service to receive an indication that the mobile device is located within a geographical region associated with the “Electronics Warehouse” store. For example, the mobile device may have an application that periodically sends location information to the advertising service without any required action on behalf of the user. In the event that an application with an available impression is present, the advertising service may “push” an advertisement to the mobile device. In the event that an application is not open or otherwise available, the advertising service may still “push” an advertisement to the mobile device (e.g., an SMS text message, MMS message, etc.).

In addition, the advertisement service may map multiple different entities to geographical locations at which these entities are located and may offer advertisers the opportunity to provide ad content to mobile devices located at these locations. For instance, the advertisement service may identify and store location information for clothing retailers, car dealerships, schools, museums, restaurants or any other type of entity that operates at a particular geographical location for any amount of time. By doing so, the advertisement service may allow advertisers to manage their activity with the advertising service by selecting or customizing the particular entities to market to, control the traffic of bid requests received from the advertising service and the like through a self-service tool or API. For instance, a car dealership that sells new cars of a first brand may indicate to the advertisement service an interest in bidding on the right to provide advertisements to mobile devices located at a different car dealership that sells new cars of a second brand, but not to a mobile device at a third car dealership that sells new cars of a third brand. Of course, while a few examples have been listed, it is to be appreciated that any other type of advertisement or other content may be served in other examples.

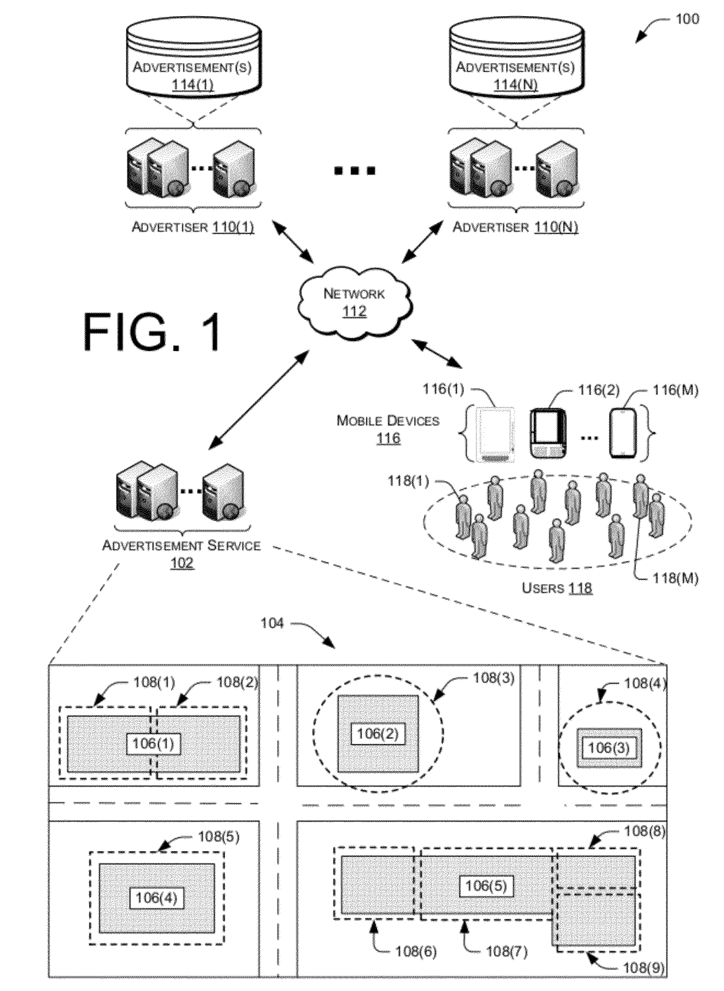

FIG. 1 illustrates an example architecture 100 in which an advertisement service 102 maps entities to geographical locations in a particular physical space, such as example physical space 104. With use of this mapping, the advertisement service 102, in a bid request sent to advertisers, may identify the particular entity (e.g., “Electronics Warehouse”), or portion thereof (e.g., flat-screen television department of “Electronics Warehouse”), that a mobile device is located within or nearby. In some embodiments, the ad content (e.g., one or more advertisements) to be displayed on the mobile device is provided by the advertiser (e.g., advertiser's ad server) and is not provided by the advertising service. In this scenario, the advertisement service 102 provides an ad tag, URL, reference or the like received from the advertiser to the ad platform (e.g., application page) on the mobile device, which provides a location of the ad content source (e.g., ad server). Ad content may refer to any content such as text, a static image, a video, audio, a game, a banner ad, a poster ad, etc. that may change over time even if the ad format (e.g., an application page, a browser page, an email message, SMS message, MMS message, etc.) provided by the publisher does not change over time. Ad content may be selectable or not.

FIG. 1, for instance, illustrates an example geographic map that includes multiple different entities 106(1), 106(2), . . . , 106(5). These entities may comprise retailers, gas stations, suppliers, schools, museums, parks or any other entity that has a determinable physical location. In addition, the advertisement service has associated geographical regions 108(1), 108(2), . . . , 108(9) around each or a portion of each of the entities 106(1)-(5). More specifically, the advertisement service 102 has stored (e.g., in a data store) a relationship between an entity or a portion of an entity and a corresponding geographical region.

The advertisement service 102 may define these regions in any number of ways. For instance, each region may comprise a particular point on the physical space 104 (e.g., a particular GPS coordinate or latitude/longitude pair) along with a certain amount of surrounding space. For instance, the circular region 108(3) may be defined as a particular point in the physical space as well as the area that is within a predefined radius of this point. In another example, the service 102 may define a geographical region as a collection of points in the physical space (e.g., a collection of GPS coordinates, latitude/longitude pairs, proximity to cell towers or Wi-Fi stations, triangulation of radio (Wi-Fi/cell towers) stations, proximity to an RF tag, image recognition, etc.). In still other instances, the regions may be defined based on signals present at those locations. For instance, the entity 106(4) may provide a wireless signal that is detectable by mobile devices at and nearby the entity. Using this example, the region 108(5) associated with entity 106(4) may be defined by the area that mobile devices are able to receive the signal provided by entity 106(4).

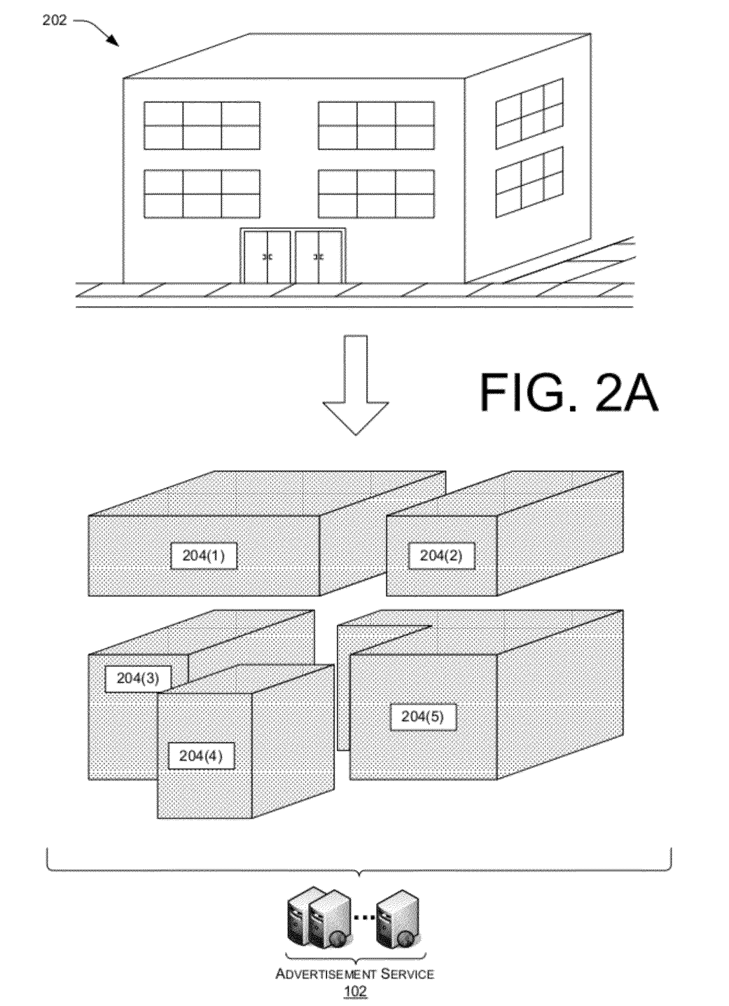

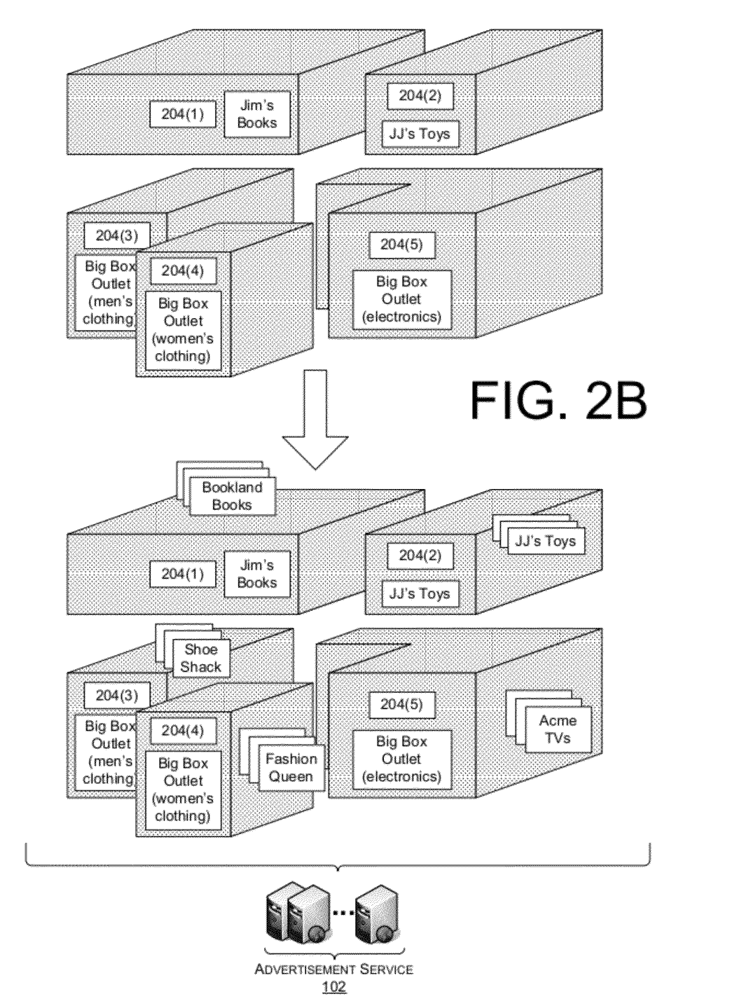

While a few examples have been given, it is to be appreciated that the advertisement service 102 or any other third party may define these geographical regions in any other manner. Further, while FIG. 1 illustrates geographical regions in two dimensions, in other instances the service 102 or another actor may map entities to defined three-dimensional regions as described with reference to FIGS. 2A-2B below. Further, the advertisement service 102 may, in some instances, tessellate an entire physical space into discrete regions, either in two or three dimensions. Here, a space, such as the physical space 104, may be entirely divided into a set of regions that includes no gaps and no overlapping regions. For instance, the physical space 104 may be tessellated into a collection of polygons of any uniform or non-uniform shapes and sizes. Of course, it is within the scope of the technology described herein to have one or more regions that overlap. The physical space may, in other example embodiments, define the physical space using visual information obtained from a camera or other imaging element (e.g., a satellite, overhead camera, etc.).

Returning to the illustrated example, after defining the regions 108(1)-(9), the advertisement service 102 may allow one or more advertisers 110(1), . . . , 110(N) the opportunity to provide ad content to a mobile device within one of the corresponding regions 108(1)-(9). In addition to (or in the alternative to) advertisers, demand-side platforms (DSPs), sell-side platforms (SSPs) and the like may responds to bid requests from the advertisement service 102 to provide ad content to a mobile device. The term “advertiser” used herein may be used interchangeably to refer to an advertiser, a DSP, an SSP and the like. More specifically, the service 102 may communicate with the advertisers over a network 112, offering the advertisers the ability to provide one or more advertisements 114(1), . . . , 114(N) to mobile devices 116(1), 116(2), . . . , 116(M) of users 118(1), . . . , 118(M) that enter a corresponding region. These mobile devices may include cellular telephones, smartphones, electronic book reader devices, laptop computers, tablets, PDAs, portable media players, entertainment devices, netbooks, gaming consoles, DVD players, and the like. The network 112, meanwhile, is representative of any one or combination of multiple different types of networks, such as the Internet, cable networks, cellular networks, wireless networks (e.g., Wi-Fi, cellular) and wired networks.

For instance, envision that the entity 106(5) comprises a mall that houses multiple other entities, such as retailers, restaurants, and the like. In addition, envision that the four regions 108(6)-(9) correspond to different stores in the mall. The advertisement service 102 may request bids from the advertisers 110(1)-(N) to provide ad content to a mobile device located in different ones of these regions 108(6)-(9). For instance, envision that the store within the region 108(6) is named “Expressions” and sells women's clothing, and that the advertiser 110(1) represents a competing women's clothing store that has an online and/or brick-and-mortar storefront. This advertiser 110(1) may accordingly be interested in bidding to provide ad content 114(1) to a mobile device in the region 108(6).

If the advertiser 110(1) provides a successful bid in response to the bid request from the advertisement service 102, then the advertisement service 102 may provide an advertisement associated with the successful advertiser to the mobile device 116(M) while the user 118(M) is visiting the “Expressions” store. This advertisement may encourage the user 118(M) to consider shopping at the competing store or may provide any other sort of content, which may or may not be tailored to the entity within the region 108(6). In some instances, this advertisement or other content may be further tailored to information known about the user 118(M), such as the user's purchase history or browsing history, items associated with a wish list and the like, as discussed in detail below.

While FIG. 1 illustrates an example architecture 100 that may implement these techniques, many other similar or different environments are possible. The example environments discussed and illustrated above are merely representative and not limiting. Various other applications, functions and advantages are presented below with respect to the various embodiments. It should be understood that the description and figures provide a number of examples, but the alternatives and variations possible within the scope of the various embodiments are not fully described. These alternatives and variations, however, would be apparent to one of ordinary skill in the art in light of the teachings and suggestions contained herein. It should be understood that reference numbers are carried over between figures to identify similar elements for purposes of simplicity of explanation alone, and this should not be interpreted as limiting the scope of the various embodiments or showing various options as part of the same embodiment.

FIGS. 2A-2B illustrate how the advertisement service 102 may define three-dimensional regions of a physical space, as opposed to, or in addition to, defining two-dimensional regions as illustrated and described above with reference to FIG. 1.

FIG. 2A illustrates a building 202 that may represent a shopping mall, an office building, a museum, a school or any other type of entity. In each instance, the building 202 may include multiple different logical entities therein. For instance, where the building comprises a school, the building 202 may include multiple different classrooms. In instances where the building comprises a museum, the building 202 may include multiple different wings or exhibits. In another example, the building 202 may include multiple different restaurants, shops, common areas and the like when the building 202 comprises a mall or other retail establishment.

In any of these instances, FIG. 2A illustrates that the advertisement service 102 may define multiple three-dimensional regions 204(1), 204(2), . . . , 204(5) within the building 202. These regions 204(1)-204(5) may represent the geographical space around the entities within the building. For instance, each region 204(1)-(5) may represent a particular store within a mall, or a particular portion and/or level of a particular store within the mall (e.g., a shoe department, appliances department, etc.), as described below.

As illustrated, the regions 204(1)-(5) may be defined in an X-Y-Z plane. For instance, the advertisement service 102 may establish regions with reference to GPS or other coordinates in the X and Y planes and with reference to elevation or another measurement in the Z plane. In some instances, the advertisement service utilizes floor plans or other known information about the building 202 in order to logically divide the building into the regions 204(1)-(5). In other instances, meanwhile, users may map out information regarding the building 202 and may upload this information to the service 102. In still other instances, the advertisement service 102 may utilize multiple techniques to define the regions. For instance, the service 102 may use a mapping program to identify a location of the building 202, while using floor plans or manual mapping techniques to divide the building 202 into the regions 204(1)-(5).

In some embodiments, the advertising service 102 may create maps of entities and surrounding areas based on information gathered or obtained by mobile devices. Mobile devices are, more and more, used to check the price of an item (e.g., by scanning the UPC code of the item). This item information (e.g., UPC code, category of item, name of item, etc.) may be obtained by the advertising service 102 and utilized to create a “mapping” of the area. For example, the advertising service 102 may have generally mapped the location of the “Electronics Warehouse” store, and then may use item information received from mobile devices within the “Electronics Warehouse” store to divide the “Electronics Warehouse” store into regions. The flat-screen television department of the “Electronics Warehouse” store, for example, may be identified based in whole or in part on receiving flat-screen television UPCs being scanned within a particular area of the store. As another example, the appliances department of the “Electronics Warehouse” store may be identified in whole or in part based on receiving appliance UPCs being scanned within another area of the store. This map refinement is not limited to UPC codes. The advertisement service 102 could also utilize images obtained by the mobile device, search queries performed on the mobile device and the like to divide a store into regions.

FIG. 2B continues the illustration of FIG. 2A and illustrates that the advertisement service 102 may associate each of the regions within a particular entity (or portion of an entity) that is located at that region. For instance, in the mall example, FIG. 2B illustrates that the advertisement service 102 has associated “Jim's Books” with the region 204(1), “JJ's Toys” with the region 204(2) and “Big Box Outlet” with the regions 204(3)-(5). Even more specifically, the advertisement service 102 has associated the “men's clothing” section of the “Big Box Outlet” store with the region 204(3), the “women's clothing” section of the store with the region 204(4) and the “electronics” section of the store with the region 204(5). By parsing the single store into multiple regions, the advertisement service 102 is able to send bid requests to advertisers indicating that a mobile device is located within (or nearby) a particular area of an entity. Providing this level of information to advertisers allows advertiser to better target their ad content. For instance, the example business of “ACME TVs” may desire to send advertisements to customers in the “electronics” section of the “Big Box Outlet” store, but not to customers in the “women's clothing” section of the “Big Box Outlet” store.

After associating these entities with the respective regions in which they reside, the advertisement service 102 may send bid requests to advertisers to secure the right to provide ad content to mobile devices at these establishments. In some instances, the advertisement service 102 sends bid requests to advertisers in response to receiving a request for an advertisement from a mobile device (e.g., an ad call). For instance, upon a user of the mobile device opening an application (e.g., weather application, game, email application, etc.), the application may cause the mobile device to send an ad call to the advertisement service 102. An ad call may include, among other things, the GPS coordinates of the mobile device, the type of application, the size of the available ad impression, the type of requested ad content, the type of mobile device, the brand of the mobile device, a period of time that the ad content will be displayed and the like.

As will be discussed in more detail later, advertisers may manage their activity with the advertisement service 102 by designating geographic regions of interest, type of traffic, maximum daily spend and the like to help manage the types and number of bid requests received from the advertisement service 102 (collectively referred to as “management information”). FIG. 2B illustrates that, based on management information provided by one or more advertisers, the advertisement service 102 has identified, for each of the regions 204(1)-(5), regions of interest for an array of different advertisers. For instance, “Bookland Books” has identified to the advertisement service 102 that they are particularly interested in receiving bid requests associated with mobile devices that are located within the region 204(1) (which encompasses “Jim's Books”). In this example, “Bookland Books” is a competitor of “Jim's Books” and may bid to provide advertisements that attempt to attract customers to purchase “Bookland's” books, either at a physical location or over a network via the mobile device itself.

Continuing the example, FIG. 2B illustrates that “Shoe Shack” has identified to the advertisement service 102 that it is interested in bidding to provide advertisements to mobile devices located at the region 204(3). Therefore, when a customer with a mobile device enters the “Men's Clothing” section of “Big Box Outlet,” the service 102 may send a bid request to “Shoe Shack,” among others, to provide a bid to provide an advertisement to this device. In addition, the service 102 identifies that “Fashion Queen” is interested in bidding to provide an advertisement to a mobile device located within the region 204(4), and “Acme TVs” is interested in bidding to provide an advertisement to a mobile device within the region 204(5). While this example illustrates a single advertiser associated with each entity, it is to be appreciated that the advertisement service 102 may associate multiple different advertisers (vendors, suppliers, merchants, distributors, etc.) with each region in some instances.

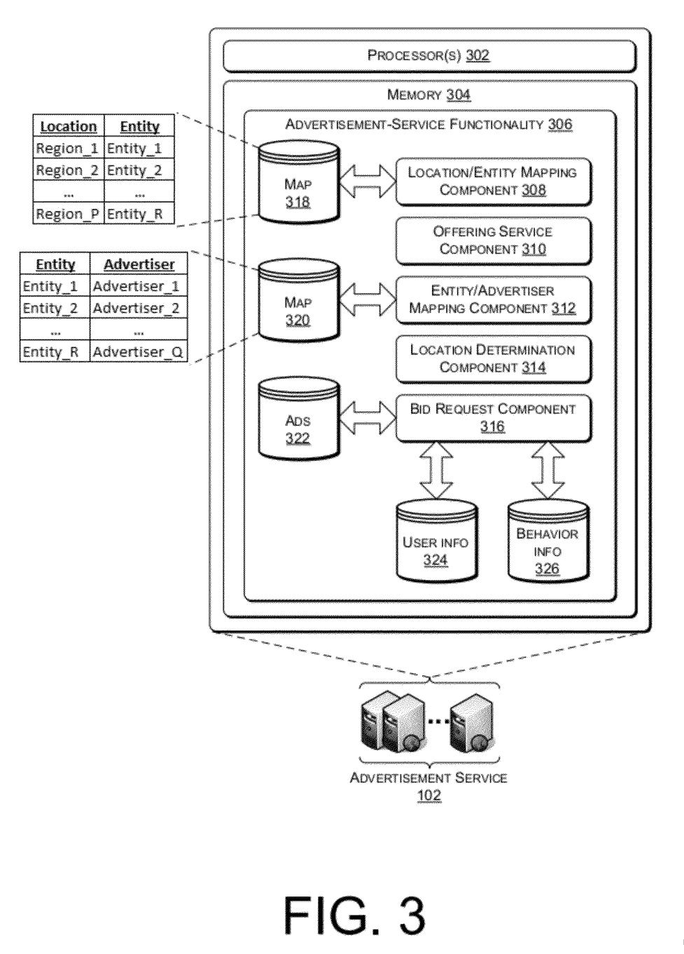

FIG. 3 depicts example components of the advertisement service 102 that may perform the techniques described above. The advertisement service 102 is illustrated as being hosted on servers that may be embodied in any number of ways, including as a single server, a cluster of servers, a server farm or data center and so forth, although other server architectures (e.g., a mainframe architecture) may also be used. Further, while FIG. 3 illustrates the components of the advertisement service 102 in one location, it is to be appreciated that these components may be distributed across actors and locations in any manner.

As illustrated, the advertisement service 102 may include one or more processors 302 and memory 304. The memory 304 (as well as the memory on other computing devices described herein) may include volatile and nonvolatile memory and/or removable and non-removable media implemented in any type or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems or any other medium which can be used to store the desired information and which can be accessed by a computing device.

As illustrated, the memory 304 stores or otherwise has access to advertisement-service functionality 306, which includes a location/entity mapping component 308, an offering service component 310, an entity/advertiser mapping component 312, a location determination component 314 and an advertisement selection component 316. The location/entity mapping component 308 stores, in a data store, indications of entities (or portions of an entity) and the geographical locations in which these entities are located. The advertisement service 102, for instance, may maintain a location-to-entity map 318. With this information, the advertisement service 102 may have knowledge of different geographical locations of different entities and associate each entity (or portion thereof) to a particular geographical region. In some instances, a particular entity (e.g., “JJ's Toys”) may be associated with a single geographical region, while in other instances a particular portion of an entity (e.g., the men's clothing department of “Big Box Outlet”) may be associated with a single geographical region. As will be discussed in more detail later, these geographic regions may vary in size and may represent a two-dimensional or three-dimensional space.

The offering service component 310, meanwhile, functions to offer, to one or more advertisers, the ability for the advertiser(s) to provide ad content to mobile devices located within a particular entity. That is, the offering service component 310 may provide interfaces that allow advertisers to bid on the right to provide ad content to mobile devices within a particular entity (e.g., “Big Box Outlet”). The offering service component 310 may also provide interfaces for other third parties to bid to provide ad content to mobile devices within a particular entity (e.g., “Big Box Outlet”). By way of example only, the offering service component 310 may provide such an interface for a DSP, an SSP, an advertising exchange, an advertising network and the like. For description purposes only, the technology disclosed herein will be described in the context of one or more advertisers providing bids to provide ad content to a mobile device. However, it is within the scope of the technology described herein to use the term “advertiser” interchangeably with any of the other third parties mentioned above.

The advertising service 102 may also provide a self-service tool or API for the advertisers to configure/predefine entities of interest, throttle bid request traffic from the advertisement service and the like to help advertisers manage their relationship with the advertisement service 102. For example, an advertiser may predefine that it would like to receive bid requests from the advertisement service 102 for an entity generally (e.g., in order to provide ad content to “Big Box Outlets” across the world), or the advertiser may only want to receive bid requests on one or more specific locations of the entity (e.g., in order to provide ad content to a particular “Big Box Outlet” or only to “Big Box Outlets” in the northwestern United States). Upon receiving this information from an advertiser, the entity/advertiser component 312 may store this configuration information. For instance, the entity/advertiser mapping component 312 may maintain an entity-to-advertiser map 320 that indicates which entities an advertiser is interested in. The advertising service 102 will deliver bid requests to advertisers based at least in part on this information provided by the advertisers.

In the map shown in FIG. 3 associated with the map store 320, “Entity_1” is associated with “Advertiser_1” and so forth, such that bid requests will be sent by the advertisement service 102 to “Advertiser_1” (in addition to other advertisers) when a mobile device enters the geographical region(s) associated with “Entity_1”.

The location determination component 314 determines when mobile devices enter (and potentially exit) a particular geographical location for the purpose of determining when to generate and deliver bid requests to advertisers. The location determination component 314 may determine mobile-device location in multiple different ways. In some instances, the mobile devices may store an application that is configured to transmit an ad request, including location information, to the advertisement service 102. This location information may include GPS coordinates, latitude/longitude pairs, elevation measurements or the like. In other instances, meanwhile, the location determination component 314 may determine or deduce the devices' locations by wireless-signal triangulation, by receiving an indication that a user has “checked in” to a particular entity via a social networking service, by tracking a user's payments history to determine where the user has recently been, by tracking acquaintances of the user to determine where the user is likely to be, proximity to Wi-Fi stations, proximity to cell towers, triangulation of radio (Wi-Fi/cell towers) stations, proximity to an RF tag, using image recognition technology and the like. In still other instances, the location determination component 314 determines or deduces a current location based on a past known location and one or more of the factors above (e.g., purchases within a specified time period, locations of friends on a social network, past behavior of the user, the past trajectory of the mobile device, etc.). In other instances, a user may input location information into the mobile device (e.g., I am in the “Big Box Outlet”) to provide data to location determination component 314.

Upon determining (or deducing) a current location of a particular mobile device, the advertisement service 102 may deliver bid requests to advertisers. First, the component 308 references the map 318 to determine if the current geographical location of the mobile device corresponds to a particular entity. If so, the entity/advertiser component 312 may reference the map 320 to determine which advertiser(s) have shown an interest (or are not interested) in the determined entity. In some embodiments, the advertising service 102 will deliver a bid request to every advertiser unless there is an express indication by the advertiser to not receive a bid request associated with the particular entity. The advertising service 102 may then generate and deliver a bid request to each advertiser.

In addition to determining the entity associated with the geographical location of the mobile device, the advertisement service 102 may also reference additional contextual information in the bid request delivered to the advertisers. For instance, the bid request component 316 may identify a user that is associated with the particular mobile device at hand and, in turn, may reference user information 324 associated with this user. This user information may include a past purchase history of the user, a browsing history of the user (e.g., on e-commerce retailers, news sites, etc.), demographic information associated with the user, interests of the users, friends of the user on social networking sites, wish lists and the like. Providing this type of information to the advertiser may further motivate an advertiser to respond to the bid request (e.g., provide a higher bid) and may help the advertiser further tailor or personalize the ad content provided to the mobile device in the event the advertiser provides the winning bid.

For instance, envision that the user information 324 indicates that the user associated with the mobile device at hand has recently purchased a flat screen LCD television, and that the user has since been browsing e-commerce retailers for an audio system that is compatible with the flat screen television. When the advertisement service 102 receives an indication (e.g., ad call) that the mobile device has entered the electronics section of “Big Box Outlet,” the bid request component 316 may provide this additional information, along with the entity, in the bid request sent to the advertisers. Of course, while one example has been given, it is to be appreciated that the user information 324 may be leveraged in any other manner.

In addition or in the alternative, the bid request component 316 may reference behavior information 326 of other users. This behavior information 326 may represent actions that other users have taken in response to receiving advertisements at a particular entity, after receiving a particular advertisement or the like. For instance, the bid request component 316 may determine that users have often purchased an item in response to receiving a first advertisement via their mobile device, while not making any purchases in response to receiving a second advertisement via their mobile device. The bid request component 316 may include this information in the bid request sent to advertisers.

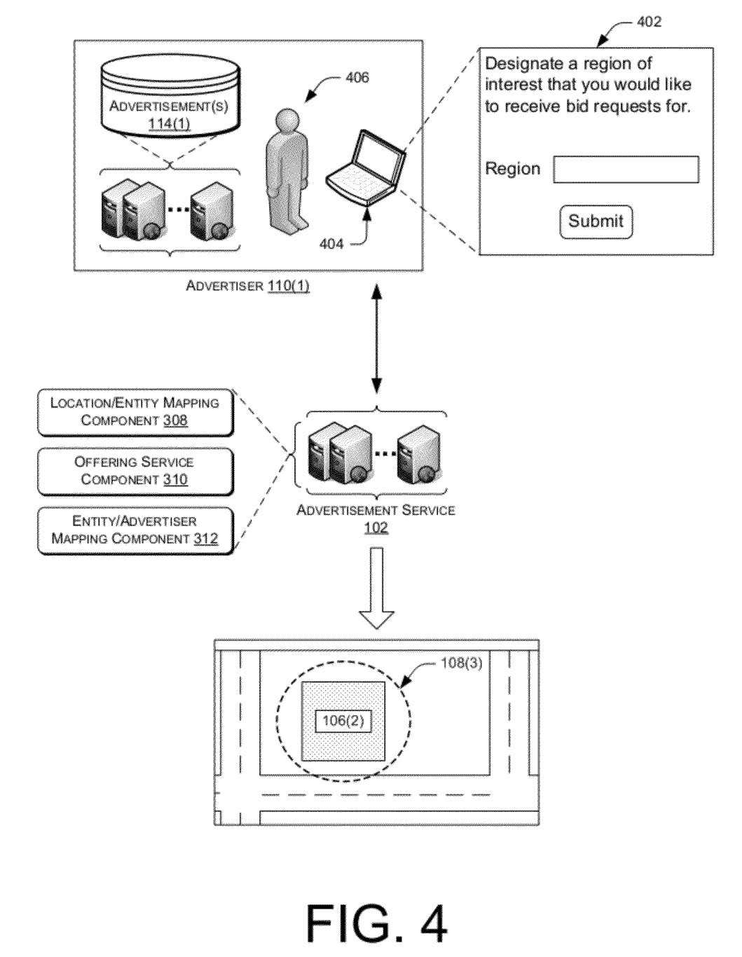

FIG. 4 illustrates an example user interface (UI) 402 that the advertisement service 102 may provide to a computing device 404 operated by a user 406 associated with an example advertiser 110(1). Here, the advertiser is interested in identifying regions of interest that the advertiser 110(1) would like to receive bid requests for and, in particular, identifying the region 108(3) (and potentially other locations in instances where the entity maintains several brick-and-mortar storefronts). As illustrated, the offering service 310 provides the UI 402, which states that the user 406 may “designate a region of interest that you would like to receive bid requests for.” These regions of interest may be designated by a numerical value (e.g., region M2175 corresponds to the men's shoe department at “Big Box Store” located in Seattle, Wash.), an interactive map, a text value (e.g., “Big Box Store”) and the like.

In some instances, the advertisement service 102 may enable advertisers to place bids for particular mobile devices and entities in real time. That is, as a mobile device enters a particular geographical region associated with a particular entity, the advertisement service 102, using a real-time bidding (RTB) system, may allow advertisers the opportunity to bid on the right to provide an advertisement to the mobile device. In these instances, the floor of the bidding process (or the preset price) may be based in whole or in part on the geographic region (e.g., 108(3)), the entity associated with the geographic region, or information associated with the user of the mobile device, such as a previous purchase history of the user, demographic information associated with the user and the like. As discussed above, advertisers may identify regions of interest that correspond to a competitor of the advertiser (e.g., “Acme TV” may identify a region of interest that corresponds to “Electronics Warehouse”). By doing so, “Acme TV” may bid to place content on a mobile device located within “Electronics Warehouse” with the intent to convince the user associated with the mobile device to purchase an item from “Acme TV” instead of “Electronics Warehouse.” Nothing described herein prevents a merchant from identifying a region of interest that corresponds to one or more of its own stores (or departments within a store). For example, a merchant may choose to participate in the advertisement service 102 by placing bids to provide advertisements on mobile devices located within its own store (or department) in an effort to prevent competitors of the store from placing one or more advertisements on the mobile device that may draw business away from the merchant.

While FIG. 4 illustrates the example UI 402, it is to be appreciated that the advertiser 110(1) may obtain the right to provide these advertisements in any other manner (e.g., via other UIs, via speaking to a human operator of the advertisement service 102, through an application programming interface (API), uploading through a data feed, etc.). In one embodiment, advertisers are presented with an interactive map in which they can select geographic regions of interest to bid upon.

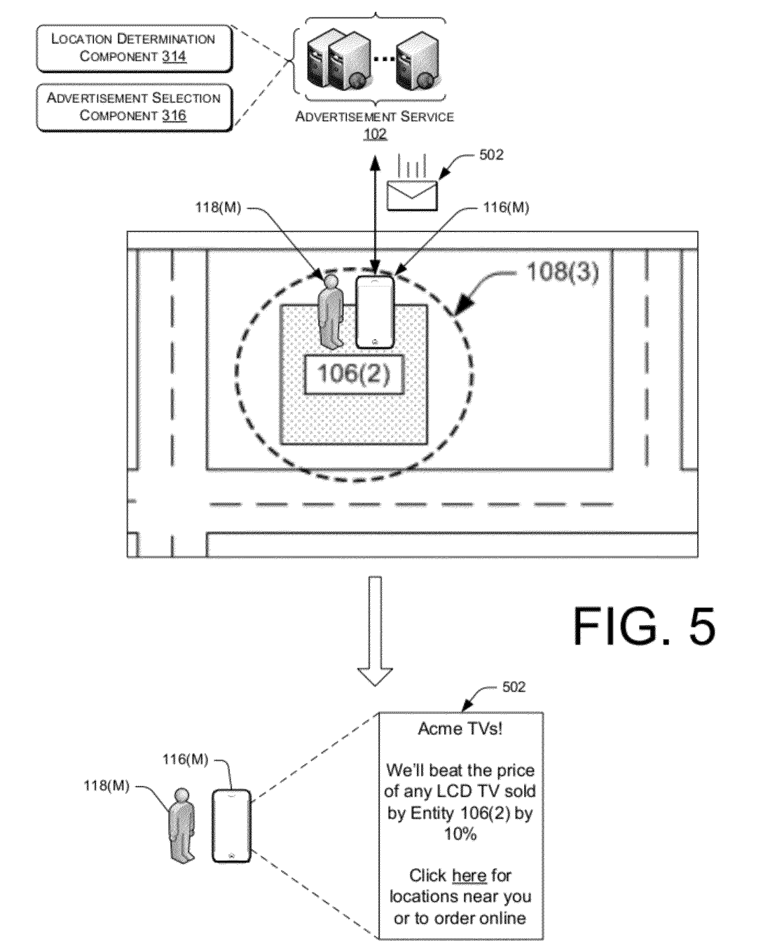

FIG. 5 illustrates an example advertisement 502 that the advertisement service 102 or another third party (e.g., DSP) may provide to mobile device 116(M) located within the particular geographical region 108(3) associated with the entity 106(2) (“TV Town”). Here, the location determination component 314 determines that the mobile device 116(M) of the user 118(M) is within the region 108(3) based on location information associated with the mobile device 116(M). As such, the advertisement service 102 delivers bid requests to advertisers to place ad content on the mobile device 116(M). In this instance, “Acme TV” provided the winning bid in response to the bid request and, as a result, advertisement 502 associated with “Acme TVs” is provided to mobile device 116(M). In some instances, this advertisement is also selected or tailored based at least in part on prior user behavior and/or on specific information about the user 118(M). As discussed above, in some embodiments, user information may be provided to the advertisers in the bid request. In other embodiments, the bid request may include, for example, a user ID (in addition to the entity) that the advertiser then utilizes to determine particular information about the user in order to help target the advertisement.

As illustrated, the example advertisement 502 states that “Acme TVs” will “beat the price of any LCD TV sold by Entity 106(2) by 10%.” The example advertisement 502 also includes a link to either locate a brick-and-mortar storefront of “Acme TVs” or to order from “Acme TVs” online. Furthermore, in some instances, the advertisement 502 may include an option for the user to toggle through advertisements from the same or different advertisers and/or to request to receive a better offer from the original advertiser or from different advertisers. In response, the advertiser may receive this request and serve another advertisement and/or negotiate with the user in real time if the advertiser so desires. In each of these instances, the techniques described herein allow the user 118(M) to be able to receive an advertisement 502 from a competitor of “TV Town” in response to the mobile device becoming located within a defined geographic location associated with “TV Town.” Similarly, in another instance, the mobile device received an advertisement 502 from a competitor of “TV Town” in response to the mobile device becoming adjacent to or within a defined distance of the geographic location associated with “TV Town.”

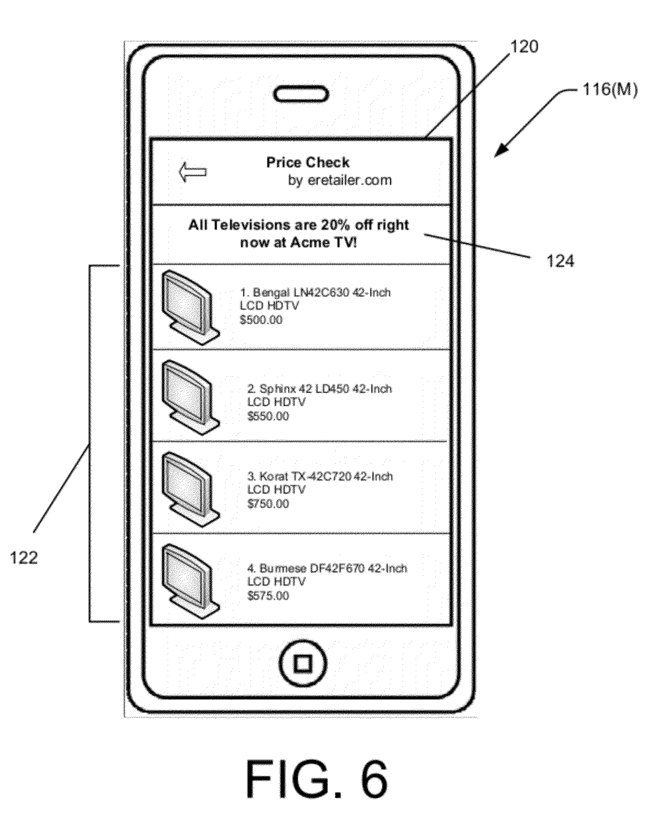

FIG. 6 depicts an example of an advertisement provided to fill an ad impression 124 within an application page on a mobile device 116(M). In this instance, suppose that a “Price Check” application has been opened on the mobile device 116(M), which is currently located in the geographic region 108(3) associated with the entity 106(2) (“TV Town”) described above with reference to FIG. 5. FIG. 6 illustrates that the “Price Check” application displays search results 122 for flat-screen televisions and an advertisement “All Televisions are 20% off right now at Acme TV!” in the ad impression 124. As will be described in more detail later, in a RTB scenario, “Acme TV” provided the winning bid to provide an advertisement in the ad impression 124 in response to a bid request received from the advertisement service 102. As a result, the “Acme TV” advertisement was displayed in the ad impression 124 along with the search results 122.

In FIG. 6, the ad impression 124 is located along the top of the search results 122. However, the ad impression 124 may be located in other areas of the screen 120 such as, but not limited to, along the bottom of the screen 120, along either side of the screen 120 or overlapping any portion of the search results 122. It is also possible that the advertisement is provided to the mobile device 116(M) via a text-message (SMS), an MMS message, an instant message (IM) and the like. An advertisement may include audio content, video content, image content or any combination thereof, in addition to (or in place of) text. Although FIG. 6 illustrates only a single ad impression 124, more than one ad impression 124 may be present at a time. It is also within the scope of the technology described herein for the advertisement displayed in the ad impression 124 to rotate after a predefined period of time.

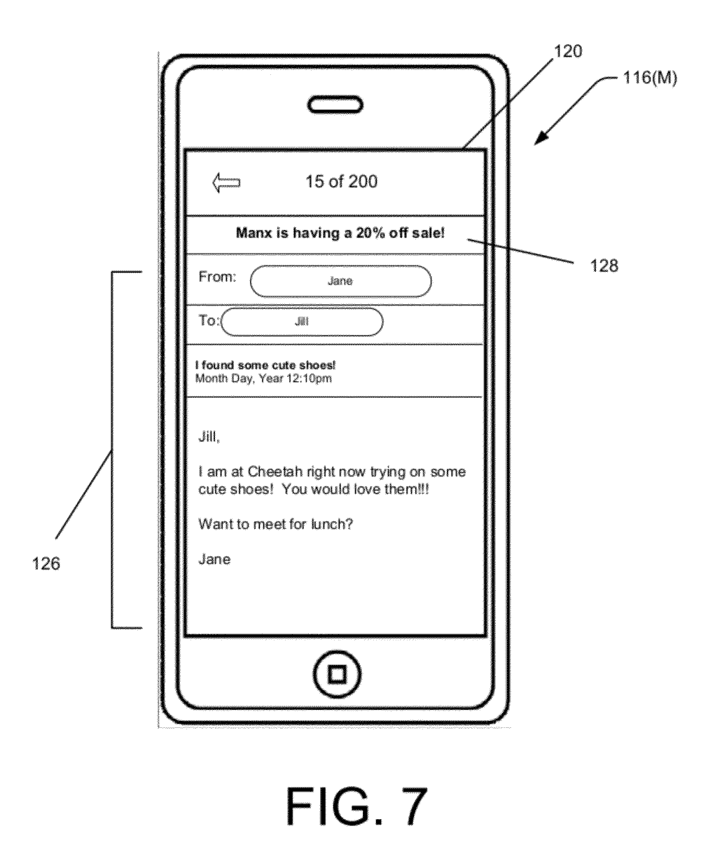

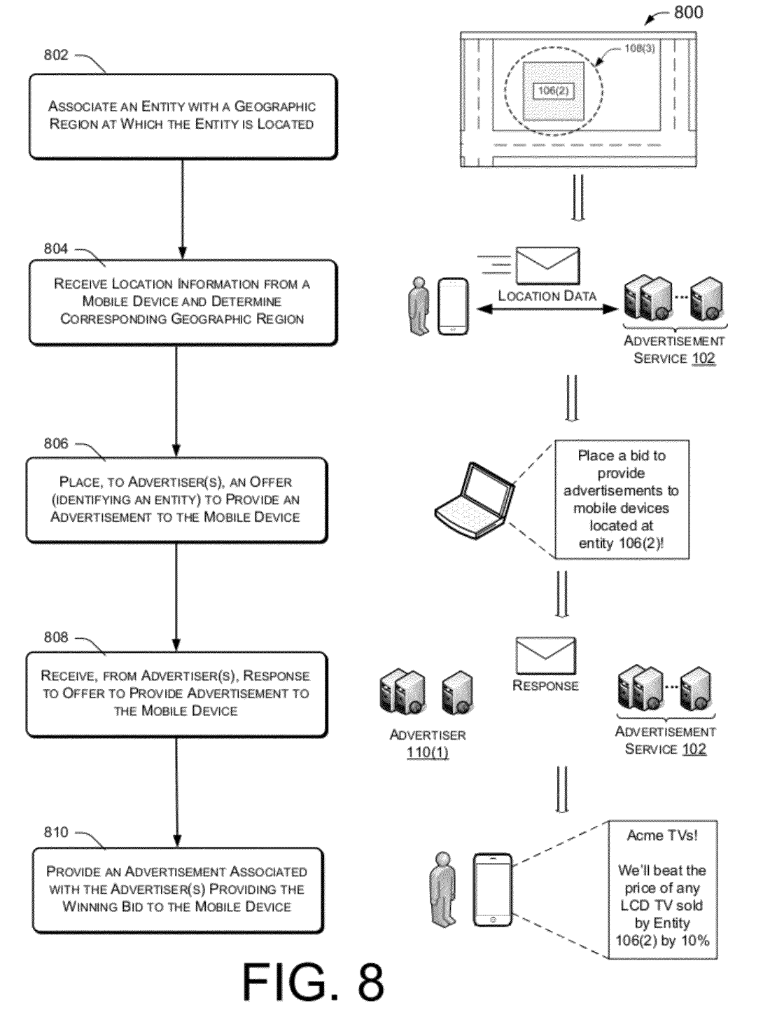

FIG. 7 depicts another example of an advertisement provided by the advertisement service 102 to fill an ad impression 128 in the context of an email message displayed on a mobile device 116(M). In this instance, suppose that the user opens her email application on her mobile device 116(M), which is currently located in geographic region 204(4) shown in FIG. 2B. FIG. 7 illustrates that the email message 126 is displayed in screen 120 of the mobile device 116(M) along with the advertisement “Mara is having a 20% off sale!” displayed in ad impression 128. In FIG. 7, the ad impression 128 is located along the top of the email message 126. However, the ad impression may be located in other areas of the screen 120 such as, but not limited to, along the bottom of the screen 120, along either side of the screen 120 or overlapping any portion of the email message 126. It is also possible that the advertisement is provided to the mobile device 116(M) via a text-message (SMS), an MMS message, an instant message (IM) and the like. As discussed above, an advertisement may include audio content, video content or image content in addition to, or in place of, text. Although FIG. 7 illustrates only a single ad impression 128, more than one ad impression 128 may be present at a time and the advertisement may rotate after a predefined period of time.

FIG. 8 provides an example process 800 for associating an entity with a geographical region, placing an offer to one or more advertisers to provide ad content to a mobile device at this region and providing the ad content to a mobile device. The process 800 (as well as each process described herein) is illustrated as a collection of operations in a logical flow graph, which represent a sequence of operations, some or all of which can be implemented in hardware, software or a combination thereof. In the context of software, the blocks represent computer-executable instructions stored on one or more computer-readable storage media that, when executed by one or more processors, perform the recited operations. Generally, computer-executable instructions include routines, programs, objects, components, data structures and the like that perform particular functions or implement particular abstract data types. The order in which the operations are described is not intended to be construed as a limitation, and any number of the described blocks can be combined in any order and/or in parallel to implement the process. For discussion purposes, the process 800 is described with reference to the architecture 100 of FIG. 1, although the process 800 may be implemented in a wide variety of other architectures.

At 802, the advertisement service 102 associates an entity with a geographical region at which the entity is located. For instance, the advertisement service 102 may store an indication of this association in a data store. In some instances, the advertisement service associates multiple different entities with multiple different geographical regions to create a rich and robust database that may be by an array of different advertisers. As described above, these geographical regions may include two- and/or three-dimensional regions (e.g., by tessellating a space). Further, these geographical regions may be absolute locations (e.g., a particular set of GPS coordinates that collectively define the region) or relative locations (e.g., “200 feet around a point that is 500 feet east and 200 feet north from the corner of Brown Street and Division Street”). In the alternative, the advertisement service 102 may acquire these geographical regions from a third party service.

At 804, the advertisement service 102 receives an indication that a mobile device is at or nearby the geographical region at which the entity is located. The advertisement service 102 may make this determination in any number of ways. For instance, the advertisement service 102 may receive GPS coordinates or other location information of the mobile device based on an event (e.g., ad call) generated by an application on the mobile device 116(M) (e.g., “Price Check” application discussed above, web browser, email application, map application, etc.). Where the geographical region comprises a set of geographical points (e.g., coordinates) that collectively define the region, the GPS coordinates or other location information received by the advertisement service 102 will indicate whether the mobile device is located within the region. Conversely, where the geographical region is defined as a single point and a threshold distance (e.g., radius) around that point, the advertisement service 102 may determine that the mobile device 116(M) is located within the geographical region by determining that the mobile device 116(M) is located within the threshold distance from the single point. Of course, while a few examples have been given, the advertisement service 102 may make this determination in 804 in any other number of ways. In one embodiment, the event generated by the application on the mobile device 116(M) is an ad call generated by the application requesting ad content. In addition to providing GPS coordinates of the mobile device 116(M), the ad call may also include, among other things, the type of mobile device, the brand of the mobile device, the time of day, a user ID of the user associated with the mobile device, the size of the ad impression, a context of the application, a duration the ad content will be displayed and the like.

At 806, the advertisement service 102 places, to one or more advertisers, an offer (also referred to as a “bid request”) to provide ad content to the mobile device located at the entity. In one embodiment, the bid request delivered by the advertisement service 102 to the one or more advertisers indicates only the entity (or section of an entity) that the mobile device is located within or nearby (e.g., mobile device is located in “Electronics Warehouse,” mobile device is located in the flat-screen television section of “Electronics Warehouse,” etc.). In other embodiments, as discussed above, the bid request delivered by the advertisement service 102 to the one or more advertisers may include additional information such as, but not limited to, the types of information mentioned above (e.g., type of mobile device, brand of mobile device, user ID, anonymized user information, purchase history, etc.).

At 808, the advertisement service 102, in response to sending the bid requests, receives from one or more advertisers, a bid to provide ad content to the mobile device. In one embodiment, a bid received from an advertiser includes a bid amount and an ad tag (e.g., a URL, reference or script tag indicating the location of the ad content). In other embodiments, a bid received from an advertiser includes a bid amount. Based on the bids received from the advertiser(s), the advertisement service 102 selects a winning bid.

At 810, in response to selecting the winning bid, the advertisement service 102, in one embodiment, provides the ad content associated with the winning bid to the mobile device. In some embodiments, the advertising service 102, in response to selecting the winning bid, then requests ad content from the advertiser that provided the winning bid. The ad content (e.g., advertisement, ad tag, etc.) returned by the advertiser is then delivered to the mobile device. In the instance whereby the advertiser provides an ad tag to the advertising service, the application page, upon being rendered, retrieves the advertisement from the ad server identified in the ad tag for display in the application page. In other embodiments, an advertiser may provide one or more advertisements or ad tags to the advertisement service 102 to store in the ads data store 322 (shown in FIG. 3). In this instance, the advertisement service 102, upon selecting a winning bid, may select an advertisement or ad tag from the ads data store 322, if available. Regardless, this ad content may have been selected by the advertiser based solely on the entity (or portion of an entity) identified in the bid request received from the advertising service 102. The ad content may have been selected by the advertiser based on any other information as well, such as information associated with the user, including demographic information, a purchase history of the user, a browsing history of the user, prior user behavior of others and the like, or any combination thereof. In another example embodiment, the selected ad content is provided to more than one device 116 (e.g., all devices 116) within a defined geographical region.

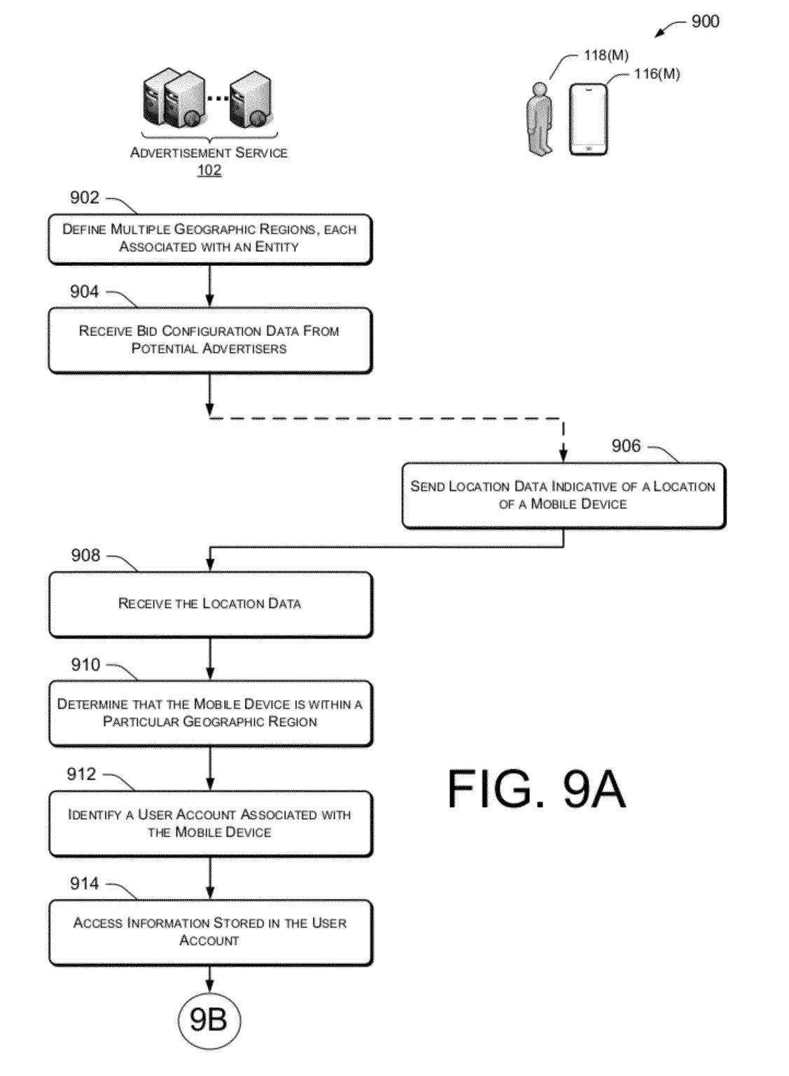

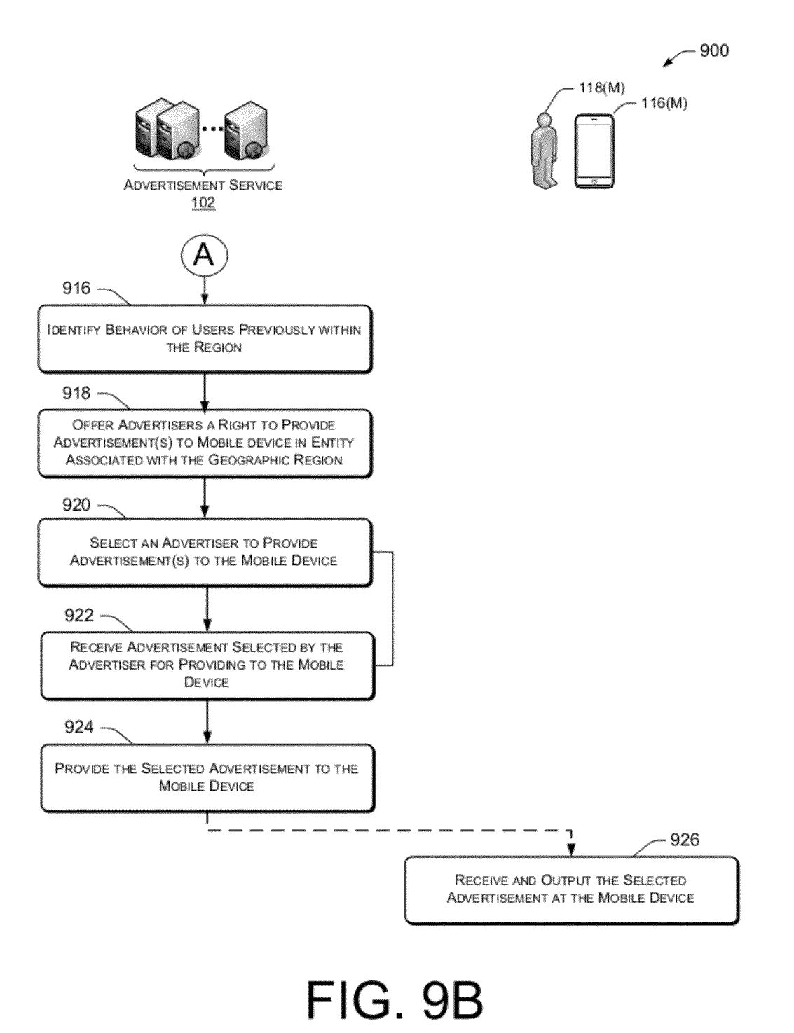

FIGS. 9A-9B depict an example process 900 for defining multiple geographic regions, offering advertisers a right to provide one or more advertisements to a mobile device within the defined region(s) and providing such advertisements to the mobile device. In this particular figure, acts illustrated underneath the advertisement service 102 may be performed by this service, while acts illustrated underneath the user 118(M) and the device 116(M) may be performed by the device 116(M). Of course, in other instances, other parties may perform some or all of these acts such as, but not limited to, a DSP, an SSP and the like performing some of the acts on behalf of the advertising service 102.

At 902, the advertisement service 102 defines multiple geographic regions. These geographic regions may be defined in two dimensions or, in some instances, in three dimensions. Furthermore, each geographical region may be associated with a particular entity (e.g., “Big Box Outlet”) or a portion of an entity (e.g., a men's clothing portion of “Big Box Outlet”). As discussed above, these geographic regions may have been created by a third party other than the advertisement service 102. In this instance, the advertising service 102 may receive definitions (and updates, if any) of the geographic regions at 902. As described above, in one instance, a user of the mobile device may provide location information of one or more entity.

At 904, the advertisement service 102 may receive configuration data from advertisers, DSPs, SSPs and the like that potentially want to provide one or more advertisements to a mobile device through the advertising service 102. This configuration data provided to the advertisement service 102 may help the advertisers manage their advertisements through a single interface with the advertisement service 102. For example, the advertisement service 102 may allow an advertiser, through a self-service tool (not shown), to provide some level of configuration as to the type of bid requests (e.g., only bid requests for impressions associated with a “Tier 1” application,” bid traffic (e.g., cap the bid requests received from the service to a certain number), particular regions of interest (e.g., shoe departments, certain malls, particular geographic regions, etc.) and the like that the advertiser would like to receive from the advertising service 102. This configuration data received at 904 is optional. For example, in the absence of any configuration data supplied by an advertiser, the advertising service 102 may send the bid request to the advertiser at 918 (described below).

Some time thereafter, the mobile device 116(M) may send location data indicative of a location of the mobile device 116(M) to the advertisement service 102 at 906. In some instances, the mobile device 116(M) stores and executes an application (e.g., provided by the advertisement service 102) that sends this location data. In other instances, as discussed above, opening a third-party application (e.g., “Price Check” application, game application, etc.) on the mobile device 116(M) generates an event or ad request that sends location information of the mobile device 116(M) to the advertising service 102, at 906. As discussed above, this location data may comprise GPS coordinates, latitude/longitude pairs, elevation measurements, an indication that the mobile device 116(M) is receiving a particular wireless signal, manual input from the user of the device indicating her position (e.g., a “check-in”) or the like. At 908, the advertisement service 102 receives the location data from the mobile device 116(M).

After receiving the location data, the advertisement service 102 may determine, at 910, a particular region in which the device is located. In one instance, the advertisement service 102 maps the location data received from the mobile device at 906 to one of the predefined geographic regions shown in FIG. 2B. For example, the advertising service 102 may determine that the mobile device 116(M) is located within or nearby region 204(4), which corresponds to the women's clothing department at “Big Box Outlet.”

In some embodiments, the advertising service 102 may provide information in the bid request in addition to the entity. In this scenario, the advertising service 102, at 912, may identify a user account associated with the mobile device and, at 914, the advertisement service 102 may access information stored in the user account. This information may include, but is not limited to, a user ID, a browsing history of the user 118(M), a purchase history of the user 118(M), demographic information of the user 118(M) and the like. The process 900 then continues in FIG. 9B.

At 916, the advertisement service 102 may identify behavior of users previously within the predefined region. This behavior may indicate whether the users ultimately purchased an item from the entity where the user 118(M) is currently located, whether the users ultimately purchased an item from an advertiser that provided an advertisement to these users while at the entity, whether the users provided feedback indicating that the advertisement was not relevant and the like.

At 918, the advertisement service 102 offers (e.g., sends out bid requests) advertisers an opportunity to select the ad content that will be provided to the mobile device 116(M) located within (or nearby) the women's clothing department at “Big Box Outlet.” In some embodiments, the bid request is for delivering an SMS text message to the mobile device 116(M). In other embodiments, the bid request is for providing ad content to fill an ad impression in an application page about to be rendered by the mobile device 116(M). In addition to identifying the entity, the bid request may also contain any other information disclosed herein.

At 920, the advertisement service 102 may identify the winning bid (e.g., advertiser that provided the highest bid). In the instance whereby there is more than one ad impression on an application page, the advertisement service 102 may select more than one winning bid at 920. In another example, where the ad content will be displayed for a first period of time, the advertisement service 102 may generate and deliver a second bid request to advertisers to provide ad content for the same application page for a second period of time. Suppose, for example, that an application page remains open for an extended period of time. The advertisement initially displayed in the application page may be replaced (rotated) with a second advertisement provided by the same advertiser or another advertiser based on the second bid request. In the alternative, the advertising service 102, upon receiving bids from the advertiser(s), may select a winning bid to provide the initial ad content and, at the same time, select a second winning bid to provide a second advertisement at a later time in the instance where an application remains open for an extended period of time.

At 922, the advertisement service 102 receives an advertisement selected by the advertiser that provided the winning bid. As discussed above, in some embodiments, the advertiser provided the advertisement with the bid. In other embodiments, the advertising service 102, upon selecting the winning bid, requests an advertisement from the advertiser that provided the winning bid. At 924, the advertisement service 102 provides the advertisement, ad tag or the like to the mobile device 116(M), and, at 926, the mobile device 116(M) receives the advertisement and displays the advertisement. As discussed above, the advertisement may include audio content, visual content, tactile content and/or any other type of content, or a combination thereof.

The information obtained at 912-916 may optimize the bidding price advertisers are willing to pay to provide the advertisement to the mobile device. For example, “Electronics Warehouse” may provide a higher bid in response to a bid request that indicates that the user spent $2,000 last year on “electronics” and has recently been browsing online retailers for a flat-screen television than if the bid request simply indicated that the mobile device is currently located at “Acme TV.” It should be readily apparent that user information would likely not be obtained without the consent of the user, such as requesting the user to opt-in to sharing such information with the advertising service 102, and would likely be anonymized such that the information could not be traced back to the particular user.

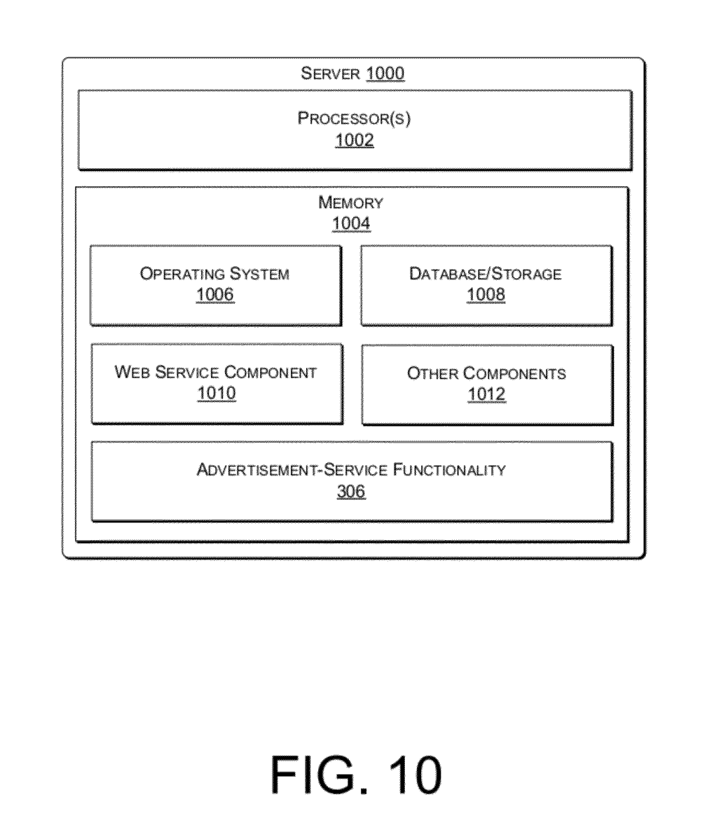

FIG. 10 depicts additional relevant components of a server 1000 that may be used to implement the functionality of the advertisement service 102. Generally, the advertisement service 102 may be implemented by one or more servers, with the various functionality described above distributed in various ways across the different servers. Servers may be located together or separately, and organized as virtual servers, server banks and/or server farms. The described functionality may be provided by the servers of a single entity or enterprise or may utilize the servers and/or services of multiple entities or enterprises.

In a very basic configuration, an example server 1000 may comprise one or more processors 1002 and memory 1004. Depending on the configuration of the server 1000, the memory 1004 may be a type of computer storage media and may include volatile and nonvolatile memory. Thus, the memory 1004 may include, but is not limited to, RAM, ROM, EEPROM, flash memory or other memory technology.

The memory 1004 may be used to store any number of functional components that are executable by the processors 1002. In many embodiments, these functional components comprise instructions or programs that are executable by the processors 1002 and that, when executed, implement operational logic for performing the actions attributed above to the advertisement service 102.

Functional components stored in the memory 1004 may include an operating system 1006 and a database 1008 to store advertisements, indications of geographical locations and the like. Functional components of the server 1000 may also comprise a web service component 1010 that interacts with remote devices such as computing devices of the advertisers 110(1)-(N) and the mobile devices 116. The server 1000 may of course include many other logical, programmatic and physical components, generally referenced by numeral 1012, of which those described above are merely examples that are related to the discussion herein. Finally, the server 1000 may include the advertisement-service functionality 306 described above with reference to FIG. 3.

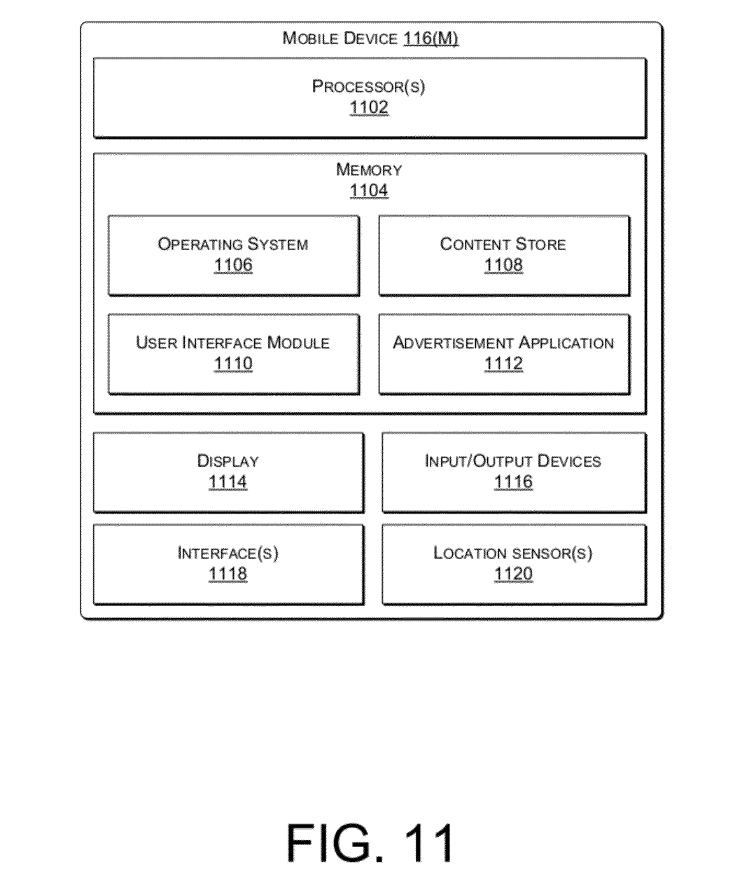

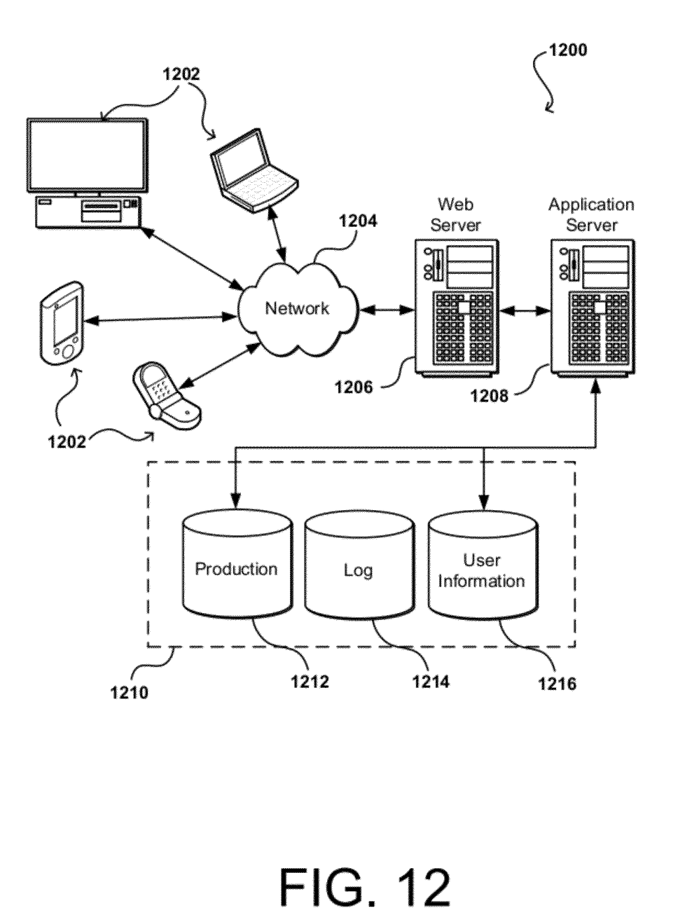

FIG. 11 depicts additional relevant components that the example mobile device 116(M) of the architecture of FIG. 1 may store or otherwise have access to. In a very basic configuration, the mobile device 116(M) includes one or more processors 1102 and memory 1104. Depending on the configuration of the mobile device 116(M), the memory 1104 may be a type of computer storage media and may include volatile and nonvolatile memory. Thus, the memory 1104 may include, but is not limited to, RAM, ROM, EEPROM, flash memory or other memory technology or any other medium which can be used to store media items or applications and data which can be accessed by the mobile device 116(M).

The memory 1104 may be used to store any number of functional components that are executable on the processors 1102. In many embodiments, these functional components comprise instructions or programs that are executable by the processors 1102 and that implement operational logic for performing the actions attributed above to the mobile device 116(M). In addition, the memory 1104 may store various types of data that are referenced by executable programs.

The memory 1104 may store an operating system 1106 and content storage 1108 to store one or more received advertisements and other content. A user interface (UI) module 1110 may also be provided in the memory 1104 and executed on the processors 1102 to provide for user operation of the mobile device 116(M). The UI module 1110 may provide menus and other navigational tools to facilitate selection and rendering of content items. The UI module 1110 may further include a browser or other application that facilitates access to sites over a network, such as websites or online merchants or other sources of electronic content items or other products.

An advertisement application 1112, meanwhile, performs some or all of the actions attributable to the mobile device 116(M) discussed above. For instance, this application 1112 may send the location information to the advertisement service 102 periodically, continuously or in any other manner. The advertisement application 1112 may also output the advertisements received from the advertisement service 102. In some instances, the advertisement application 1112 performs additional functionality other than simply displaying advertisements, while in other instances the application 1112 is a standalone application.

The mobile device 116(M) may further include a display 1114 upon which advertisements and/or other content items are rendered. The mobile device 116(M) may further be equipped with various input/output devices 1116. Such components may include various user interface controls (e.g., buttons, joystick, keyboard, touch screen, etc.), audio speakers, connection ports and so forth.

One or more interfaces 1118 may support both wired and wireless connection to various networks, such as cellular networks, radio, Wi-Fi networks, short range networks (e.g., Bluetooth), IR and so forth. The interfaces 1118 may facilitate sending location data to and receiving advertisements from the advertisement service 102 as described herein. The mobile device 116(M) may also include one or more location sensors 1120 for determining a current location of the device. The location sensors 1120 may include a GPS unit or any other sensor capable of determining or inferring a location of the mobile device 116(M).

The mobile device 116(M) may have additional features or functionality. For example, the mobile device 116(M) may also include additional data storage devices (removable and/or non-removable) such as, for example, magnetic disks, optical disks or tape. The additional data storage media may include volatile and nonvolatile, removable and non-removable media implemented in any method or technology for storage of information, such as computer readable instructions, data structures, program modules or other data.

As discussed, different approaches can be implemented in various environments in accordance with the described embodiments. For example, FIG. 12 illustrates an example of an environment 1200 for implementing aspects in accordance with various embodiments. As will be appreciated, although a Web-based environment is used for purposes of explanation, different environments may be used, as appropriate, to implement various embodiments. The system includes an electronic client device 1202, which can include any appropriate device operable to send and receive requests, messages or information over an appropriate network 1204 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server 1206 for receiving requests and serving content in response thereto, although for other networks an alternative device serving a similar purpose could be used, as would be apparent to one of ordinary skill in the art.

The illustrative environment includes at least one application server 1208 and a data store 1210. It should be understood that there can be several application servers, layers or other elements, processes or components, which may be chained or otherwise configured, which can interact to perform tasks such as obtaining data from an appropriate data store. As used herein the term “data store” refers to any device or combination of devices capable of storing, accessing and retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server in the form of HTML, XML or another appropriate structured language in this example. The handling of all requests and responses, as well as the delivery of content between the client device 1202 and the application server 1208, can be handled by the Web server 1206. It should be understood that the Web and application servers are not required and are merely example components, as structured code discussed herein can be executed on any appropriate device or host machine as discussed elsewhere herein.

The data store 1210 can include several separate data tables, databases or other data storage mechanisms and media for storing data relating to a particular aspect. For example, the data store illustrated includes mechanisms for storing production data 1212 and user information 1216, which can be used to serve content for the production side. The data store also is shown to include a mechanism for storing log or session data 1214. It should be understood that there can be many other aspects that may need to be stored in the data store, such as page image information and access rights information, which can be stored in any of the above listed mechanisms as appropriate or in additional mechanisms in the data store 1210. The data store 1210 is operable, through logic associated therewith, to receive instructions from the application server 1208 and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device 1202. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 12. Thus, the depiction of the system 1200 in FIG. 12 should be taken as being illustrative in nature and not limiting to the scope of the disclosure.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS and AppleTalk. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response to requests from user devices, such as by executing one or more Web applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random access memory (“RAM”) or read-only memory (“ROM”), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
under control of one or more computer systems configured with specific executable instructions,
receiving, from a mobile device, an indication that an advertisement impression is available for display of an advertisement on the mobile device located within or nearby a geographical region;
determining an entity associated with the geographical region;
providing, to one or more advertisers, an offer to provide an advertisement for display in the available impression, wherein the offer includes an identification of the determined entity;
receiving, from at least one of the one or more advertisers, a bid to provide an advertisement for display in the available impression, wherein the advertisement is of a competitor to the entity;
selecting an advertiser to provide an advertisement for display in the available impression based on the received bids; and
providing information to the mobile device for display of the advertisement of the selected advertiser in the available impression.

2. The method of claim 1, wherein the determined entity represents a brick-and-mortar store and the identification of the determined entity included in the offer provided to one or more advertisers identifies a particular section of the brick-and-mortar store.

3. The method of claim 1, wherein the determined entity represents a plurality of brick-and-mortar stores.

4. The method of claim 1, wherein the providing information to the mobile device comprises providing an advertisement to the mobile device.

5. The method of claim 1, wherein the providing information to the mobile device comprises providing an advertisement tag to the mobile device.

6. The method of claim 1, wherein the geographical region represents a three dimensional space, further comprising:
determining that the mobile device is located within or nearby the geographical region based at least in part on location information received from the mobile device.

7. The method of claim 1, wherein the mobile device is associated with a user, further comprising:
determining information associated with the user; and
wherein the offer provided to one or more advertisers further includes at least a portion of the determined user information in addition to the identification of the determined entity.

8. The method of claim 7, wherein the information associated with the user comprises at least one of the following: a purchase history, a browsing history, demographic data and a wish list.

9. The method of claim 1, further comprising:
determining a context associated with the advertisement impression; and
wherein the offer provided to one or more advertisers further identifies the determined context in addition to the identification of the determined entity.

10. The method of claim 1, wherein the advertisement of the selected advertiser is displayed in the available impression for a first period of time.

11. The method of claim 10, further comprising:
prior to expiration of the first period of time, providing, to one or more advertisers, a second offer to provide a second advertisement for display in the available impression, wherein the offer includes an identification of the determined entity;
receiving, from at least one of the one or more advertisers, a bid to provide a second advertisement for display in the available impression upon expiration of the first period of time;
selecting an advertiser to provide a second advertisement for display in the available impression based on the received second bids; and
providing information to the mobile device for display of the second advertisement of the selected second advertiser in the available impression.

12. One or more computing devices comprising:
one or more processors; and
one or more computer-readable media storing computer-executable instructions that, when executed, cause one or more processors to perform acts comprising:
determining that a mobile device is within a geographic region;
determining an entity associated with the determined geographic region;
requesting bids from one or more advertisers to provide an advertisement to the mobile device, wherein the one or more advertisers provides a bid based at least in part on the determined entity;
selecting at least one bid provided by the one or more advertisers in response to the request for bids to provide an advertisement to the mobile device; and
providing information to the mobile device for display of the advertisement associated with the selected at least one bid.

13. The one or more computing devices of claim 12, wherein the determining that the mobile device is within the geographic region comprises:
receiving location information from the mobile device; and
identifying a geographic region based at least in part on the received location information.

14. The one or more computing devices of claim 12, wherein the determining that the mobile device is within the geographic region comprises receiving Global Positioning Satellite (GPS) coordinates and an elevation indication from the mobile device.

15. The one or more computing devices of claim 12, wherein the determining that the mobile device is within the geographic region comprises deducing a current location of the mobile device based at least in part on a past known location of the mobile device and a current or past known location of one or more users other than a user associated with the mobile device.

16. The one or more computing devices of claim 12, wherein the determining that the mobile device is within the geographic region comprises deducing a current location of the mobile device based at least in part on a past known location and one or more additional actions taken by the mobile device within a specified time period.

17. The one or more computing devices of claim 16, wherein the one or more additional actions comprise a user of the mobile device checking in to a particular entity using a social networking service or making a payment at a particular entity.

18. The one or more computing devices of claim 12, wherein at least one bid provided by the one or more advertisers was provided by a demand-side platform on behalf of an advertiser.

19. The one or more computing devices of claim 12, further comprising:
identifying a user account associated with the mobile device;
accessing information stored in the user account at least partly in response to the identifying of the user account; and
wherein the one or more advertisers provides a bid based on at least a portion of the accessed information stored in the user account in combination with the determined entity.

20. The one or more computing devices of claim 19, wherein the information stored in the user account comprises at least one of the following: a purchase history, a browsing history and demographic information.

21. A method comprising:
under control of one or more computer systems configured with specific executable instructions,
defining multiple geographic regions, each geographic region representing at least a portion of an entity; and
in response to receiving a geographic location from a mobile device,
determining at least one geographic region associated with the received geographic location; and
providing bid requests to one or more advertisers to provide an advertisement to the mobile device, the bid requests identifying the at least a portion of an entity corresponding to the determined geographic region.

22. The method of claim 21, further comprising:
receiving, from the one of the one or more advertisers, bids to provide an advertisement to the mobile device; and
in response to receiving bids from the one or more advertisers, selecting an advertiser providing a highest bid.

23. The method of claim 21, wherein the multiple geographic regions are each defined in two-dimensional space.

24. The method of claim 21, wherein the multiple geographic regions are each defined in three-dimensional space.

25. The method of claim 21, wherein the at least a portion of an entity corresponding to the determined geographic region comprises a retailer that offers goods or services.

26. The method of claim 21, wherein the at least a portion of an entity corresponding to the determined geographic region comprises an area within a retailer.

27. The method of claim 21, wherein:
at least one particular entity comprises a retailer that offers goods or services; and
the portion of the particular entity offers, at the respective region, a specified category of the goods or services offered by the retailer.

28. One or more computer-readable media storing computer-executable instructions that, when executed, cause one or more processors of a mobile device to perform acts comprising:
providing location data indicative of a location of the mobile device; and
receiving ad content at least partly in response to the providing of the location data, the ad content associated with an advertiser that bid to provide the ad content based at least in part on an entity corresponding to the provided location data.

29. The one or more computer-readable media of claim 28, wherein the receiving ad content comprises receiving information identifying a location to obtain an advertisement.

30. The one or more computer-readable media of claim 28, wherein the providing location data indicative of a location of the mobile device is in response to an event generated by an application operating on the mobile device.

31. The one or more computer-readable media of claim 28, wherein the entity comprises at least a portion of an entity.

32. The one or more computer-readable media of claim 28, wherein the providing location data indicative of the location of the mobile device comprises providing at least one of a GPS coordinate and an elevation coordinate.

33. The one or more computer-readable media of claim 28, wherein the ad content comprises an advertisement from a competitor of the entity corresponding to the provided location data.
